(19) United States
(12) Patent Application Publication
(10) Pub. No.: US 2012/0062621 A1
(43) Pub. Date: Mar. 15, 2012

(54) BRIGHTNESS ADJUSTING DEVICE

(75) Inventors: Koji Miyahara, Tokyo (JP); Yohei Miki, Tokyo (JP); Hitoshi Fujimoto, Tokyo (JP)

(73) Assignee: MITSUBISHI ELECTRIC CORPORATION, TOKYO (JP)

(21) Appl. No.: 13/321,633

(22) PCT Filed: Aug. 28, 2009
(86) PCT No.: PCT/JP2009/004225

§ 371 Date: Nov. 21, 2011

(51) Int. Cl. G09G 5/10

(52) U.S. Cl. 345/690

(57) ABSTRACT

A brightness adjusting device including a display unit position determining part for determining the position of each display unit in a coordinate system on a pattern image shot by a camera, a shooting angle determining part for determining a shooting angle of the camera with respect to each display unit from the pattern image, and a brightness measuring part for determining the display image displayed on each display unit in the pattern image with reference to the position of each display unit to measure the brightness of each display unit, and adjusts the brightness of an image display device in consideration of the light distribution characteristic value of the image display device, the shooting angle measured by the shooting angle determining part, and the brightness of each display unit measured by the brightness measuring part.

### FIELD OF THE INVENTION

The present invention relates to a brightness adjusting device which adjusts the brightness of each of a large number of display units which construct an image display device.

### BACKGROUND OF THE INVENTION

A brightness adjusting device which adjusts the brightness of each of a large number of display units which construct an image display device is disclosed in, for example, the following patent reference 1.

This brightness adjusting device projects a test pattern on the screen of the image display device, and a shooting unit shoots the test pattern projected onto the screen from a predetermined camera shooting position.

Next, this brightness adjusting device converts the image data of the test pattern into characteristic data which must be acquired when shooting the test pattern from a predetermined observation position (a position different from the camera shooting position of the above-mentioned shooting unit) by using a transform function which has been determined in advance.

This brightness adjusting device then corrects the display properties of the image display device according to that characteristic data.

### RELATED ART DOCUMENT

### Patent Reference

Patent reference 1: Japanese Unexamined Patent Application Publication No. 2005-99150 (paragraph number [0021])

### SUMMARY OF THE INVENTION

Because the conventional brightness adjusting device is constructed as above, the conventional brightness adjusting device needs to shoot an image at a predetermined position where the brightness adjusting device faces the screen when determining the transform function, and, when shooting the test pattern projected onto the screen, also needs to shoot each measurement point by using a nearly central portion of the image sensor. Thus, there are constraints on the camera shooting position. Therefore, a problem is that the brightness of each of the large number of display units which construct the image display device cannot be adjusted easily, and luminance spots may appear.

The present invention is made in order to solve the above-mentioned problem, and it is therefore an object of the present invention to provide a brightness adjusting device which can adjust the brightness of an image display device and reduce luminance spots without constraints on the camera shooting position.

In accordance with the present invention, there is provided a brightness adjusting device including: a pattern image shooting unit for displaying a pattern image for brightness measurement on a plurality of display units which construct an image display device to shoot a pattern image which is a display image displayed on the plurality of display units; a display unit position determining unit for determining a position of each of the display units in a coordinate system on the pattern image shot by the pattern image shooting unit; a shooting angle determining unit for determining a shooting angle of the pattern image shooting unit with respect to each of the display units from the pattern image shot by the pattern image shooting unit; and a brightness measuring unit for determining a display image displayed on each of the display units in the pattern image shot by the pattern image shooting unit with reference to the position of each of the display units determined by the display unit position determining unit to measure brightness of each of the display units, and a brightness adjusting unit acquires a light distribution characteristic value of the image display device from the shooting angle determined by the shooting angle determining unit to adjust the brightness of the image display device in consideration of the light distribution characteristic value and the brightness of each of the display units measured by the brightness measuring unit.

Because the brightness adjusting device in accordance with the present invention is constructed in such a way that it includes the pattern image shooting unit for displaying a pattern image for brightness measurement on the plurality of display units which construct the image display device to shoot a pattern image which is a display image displayed on the plurality of display units, the display unit position determining unit for determining the position of each of the display units in the coordinate system on the pattern image shot by the pattern image shooting unit, the shooting angle determining unit for determining the shooting angle of the pattern image shooting unit with respect to each of the display units from the pattern image shot by the pattern image shooting unit, and the brightness measuring unit for determining the display image displayed on each of the display units in the pattern image shot by the pattern image shooting unit with reference to the position of each of the display units determined by the display unit position determining unit to measure the brightness of each of the display units, and the brightness adjusting unit acquires the light distribution characteristic value of the image display device from the shooting angle determined by the shooting angle determining unit to adjust the brightness of the image display device in consideration of the light distribution characteristic value and the brightness of each of the display units measured by the brightness measuring unit, there is provided an advantage of being able to adjust the brightness of the image display device and reduce luminance spots without constraints on the camera shooting position.

### BRIEF DESCRIPTION OF THE FIGURES

FIG. 1 is a block diagram showing a brightness adjusting device in accordance with Embodiment 1 of the present invention;

FIG. 2 is an explanatory drawing showing an example in which an image display device 1 is comprised of 24 display units (display units arranged in three rows and eight columns);

FIG. 3 is a flow chart showing a process carried out by a display unit position determining part 3 of the brightness adjusting device in accordance with Embodiment 1 of the present invention;

FIG. 4 is an explanatory drawing showing a pattern image shot by a camera 2b of a pattern image shooting part 2;

FIG. 5 is an explanatory drawing showing the positions of four corners of the image display device 1 in a coordinate system on a space in which the image display device 1 is installed;

FIG. 6 is an explanatory drawing showing a shooting angle (an angle along a horizontal direction) of the camera 2b with respect to an x axis of the image display device 1;

FIG. 7 is an explanatory drawing showing a shooting angle (an angle along a vertical direction) of the camera 2b with respect to a y axis of the image display device 1;

FIG. 8 is a flow chart showing a process carried out by a brightness measuring part 5 of the brightness adjusting device in accordance with Embodiment 1 of the present invention;

FIG. 9 is a flow chart showing a process carried out by a light distribution characteristic determining part 6 of the brightness adjusting device in accordance with Embodiment 1 of the present invention;

FIG. 10 is an explanatory drawing showing a reference unit region;

FIG. 11 is an explanatory drawing showing an example of a brightness information table created by the light distribution characteristic determining part 6;

FIG. 12 is a flow chart showing a process carried out by a correction value calculating part 8 of the brightness adjusting device in accordance with Embodiment 1 of the present invention;

FIG. 13 is a block diagram showing a brightness adjusting device in accordance with Embodiment 2 of the present invention;

FIG. 14 is an explanatory drawing showing an example of rearrangement of a plurality of display units;

FIG. 15 is a block diagram showing a brightness adjusting device in accordance with Embodiment 3 of the present invention;

FIG. 16 is a flow chart showing a process carried out by a pattern image shooting part 2 of the brightness adjusting device in accordance with Embodiment 3 of the present invention;

FIG. 17 is a flow chart showing a process of calculating a correction value for each image sensor;

FIG. 18 is a block diagram showing a brightness adjusting device in accordance with Embodiment 4 of the present invention; and

FIG. 19 is a flow chart showing a process carried out by a pattern image shooting part 2 of the brightness adjusting device in accordance with Embodiment 4 of the present invention.

### EMBODIMENTS OF THE INVENTION

Hereafter, in order to explain this invention in greater detail, the preferred embodiments of the present invention will be described with reference to the accompanying drawings.

### Embodiment 1

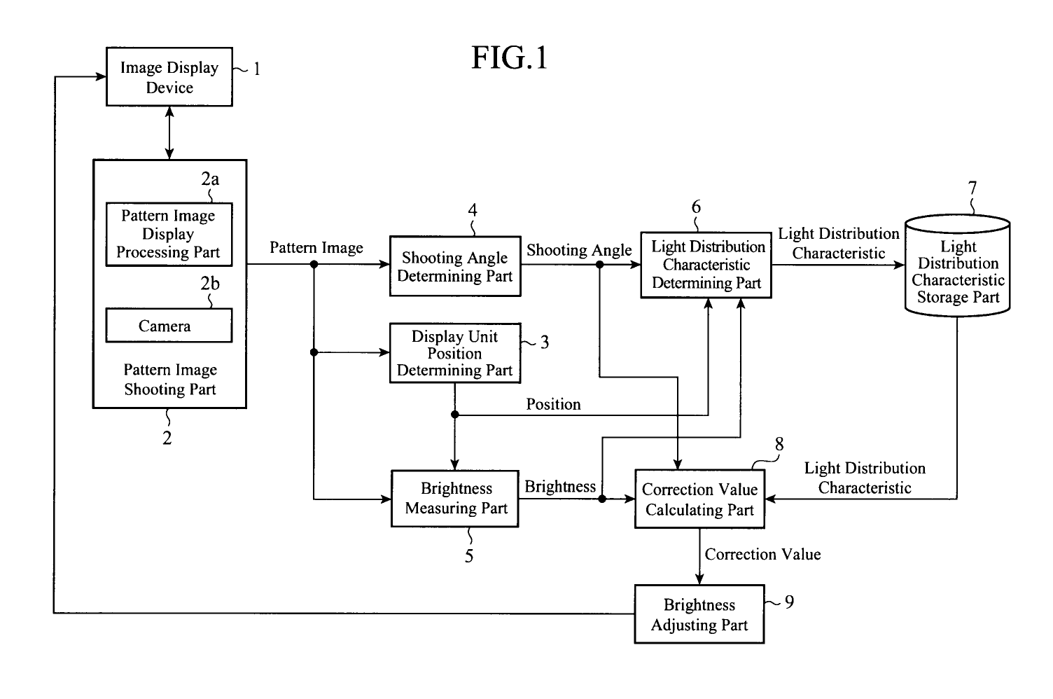

FIG. 1 is a block diagram showing a brightness adjusting device in accordance with Embodiment 1 of the present invention.

In FIG. 1, an image display device 1 is the one having a large screen in which a large number of display units (N×M display units, e.g., a total of 24 display units arranged in three rows and eight columns) are arranged in vertical and horizontal directions. A pattern image shooting part 2 is comprised of a pattern image display processing part 2a for displaying a pattern image for brightness measurement on all the display units of the image display device 1, and a camera 2b for shooting a display image displayed on all the display units of the image display device 1 (a pattern image currently being displayed by the pattern image display processing part 2a).

The pattern image shooting part 2 constructs a pattern image shooting unit.

A display unit position determining part 3 carries out a process of determining the position of each of the display units in a coordinate system on the pattern image shot by the camera 2b of the pattern image shooting part 2 by determining a projective transformation matrix P (coordinate transformation matrix) showing a correspondence between a coordinate system on the image display device in which the large number of display units which construct the image display device 1 are installed, and the coordinate system on the pattern image, and then converting coordinates (Sₓ, S_{y}, S_{z}) showing the position where each of the display units is installed into coordinates (Iₓ, I_{y}) on the pattern image by using the projective transformation matrix P. The display unit position determining part 3 constructs a display unit position determining unit.

A shooting angle determining part 4 carries out a process of referring to the position of each of the display units determined by the display unit position determining part 3, and determining shooting angles α and β of the camera 2b with respect to the center of each of the display units (α is the shooting angle of the camera 2b with respect to the direction of the x axis of the coordinate system on a space in which the image display device 1 is installed, and β is the shooting angle of the camera 2b with respect to the direction of the y axis of the coordinate system on the space in which the image display device 1 is installed). The shooting angle determining part 4 constructs a shooting angle determining unit.

A brightness measuring part 5 carries out a process of referring to the position of each of the display units determined by the display unit position determining part 3 to determine a display image displayed on each of the display units in the pattern image shot by the camera 2b of the pattern image shooting part 2, and calculating the average L of the values of the plurality of pixels which construct the display image (the brightness of each of the display units). The brightness measuring part 5 constructs a brightness measuring unit.

A light distribution characteristic determining part 6 carries out a process of determining a light distribution characteristic f(α,β) of the image display device 1 from both the shooting angles α and β with respect to each of the display units determined by the shooting angle determining part 4, and the brightness L of each of the display units measured by the brightness measuring part 5. The light distribution characteristic determining part 6 constructs a light distribution characteristic determining unit.

A light distribution characteristic storage part 7 is a memory for storing the light distribution characteristic f(α,β) of the display units of the image display device 1 which is determined by the light distribution characteristic determining part 6.

Although in this Embodiment 1 the example in which the light distribution characteristic storage part 7 stores the light distribution characteristic f(α,β) determined by the light distribution characteristic determining part 6 is shown, when the light distribution characteristic f(α,β) is known in advance, the light distribution characteristic determining part 6 can be eliminated and the light distribution characteristic storage part 7 stores the known light distribution characteristic f(α,β).

A correction value calculating part 8 carries out a process of calculating a correction value H used for adjusting the brightness of each of the large number of display units which construct the image display device 1 in consideration of the light distribution characteristic f(α,β) of the image display device 1 stored in the light distribution characteristic storage part 7, the shooting angles α and β of the camera 2b with respect to the center of each of the display units determined by the shooting angle determining part 4, and the brightness L of each of the display units measured by the brightness measuring part 5.

A brightness adjusting part 9 carries out a process of adjusting the brightness L of each of the large number of display units by using the correction value H calculated by the correction value calculating part 8.

A brightness adjusting unit is comprised of the correction value calculating part 8 and the brightness adjusting part 9.

In the example of FIG. 1, although it is assumed that each of the pattern image shooting part 2, the display unit position determining part 3, the shooting angle determining part 4, the brightness measuring part 5, the light distribution characteristic determining part 6, the correction value calculating part 8, and the brightness adjusting part 9 which are the components of the brightness adjusting device is constructed of hardware for exclusive use (e.g., an integrated circuit in which a CPU is mounted or a one chip microcomputer), the brightness adjusting device can be alternatively constructed of a computer, and, in this case, a program in which processes performed by the pattern image shooting part 2, the display unit position determining part 3, the shooting angle determining part 4, the brightness measuring part 5, the light distribution characteristic determining part 6, the correction value calculating part 8, and the brightness adjusting part 9 are described can be stored in a memory of the computer, and a CPU mounted in the computer can execute the program stored in the memory.

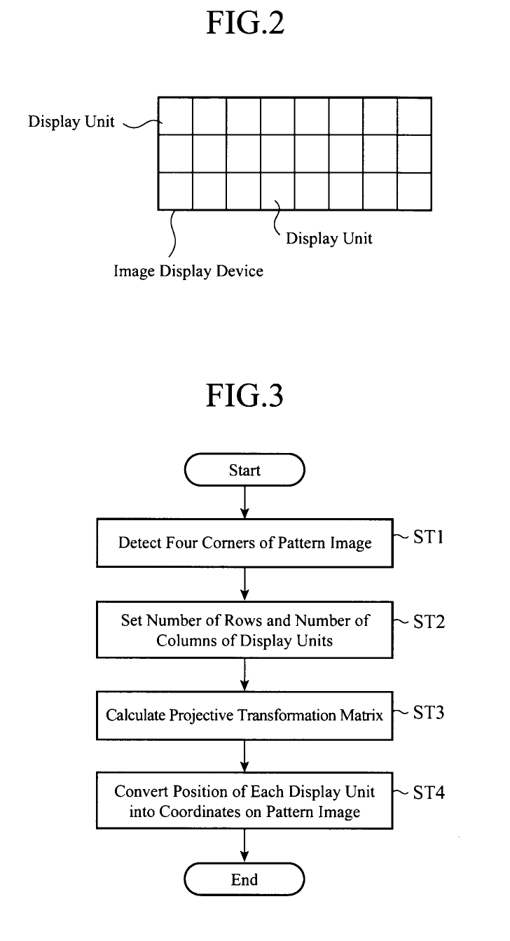

FIG. 2 is an explanatory drawing showing an example in which the image display device 1 is comprised of 24 display units (display units arranged in three rows and eight columns). In the example of FIG. 2, each of the display units has a square shape.

Next, the operation of the brightness adjusting device will be explained.

First, the pattern image display processing part 2a of the pattern image shooting part 2 displays an image having a single color, such as only green, on all the display units of the image display device 1 as a pattern image for brightness measurement.

When the pattern image display processing part 2a displays the pattern image on all the display units, the camera 2b of the pattern image shooting part 2 shoots an image of an area covering the whole surface of the image display device 1 (an image of an area including the display image displayed on all the display units).

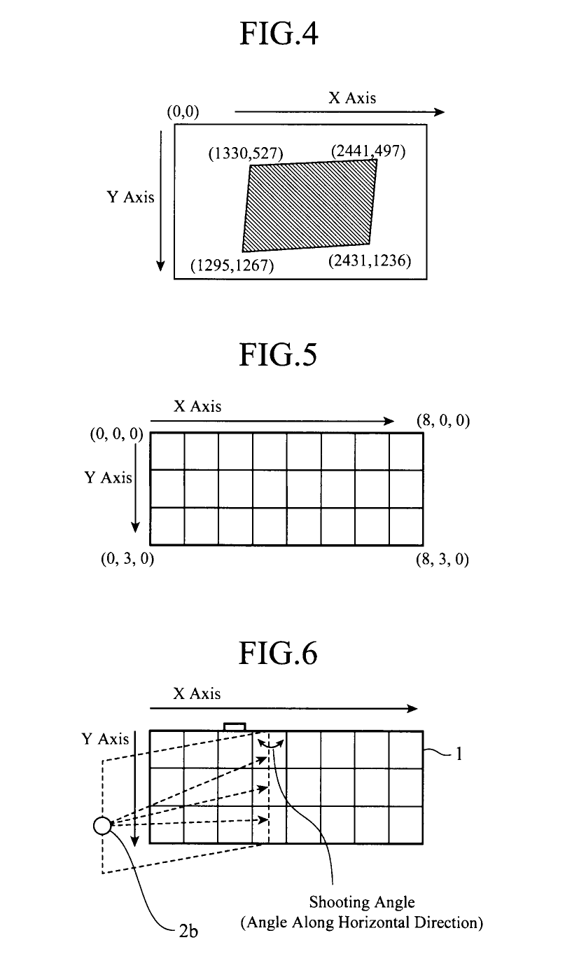

FIG. 4 is an explanatory drawing showing the pattern image shot by the camera 2b of the pattern image shooting part 2.

In FIG. 4, a hatched portion shows the pattern image currently being displayed on all the display units, and the outside of the hatched portion shows a portion located outside the image display area of all the display units.

After the camera 2b of the pattern image shooting part shoots the pattern image, the display unit position determining part 3 carries out the process of determining the position of each of the display units in the coordinate system on the pattern image.

Hereafter, the process carried out by the display unit position determining part 3 will be explained concretely.

FIG. 3 is a flow chart showing the process carried out by the display unit position determining part 3 of the brightness adjusting device in accordance with Embodiment 1 of the present invention.

First, the display unit position determining part 3 detects the display image (pattern image) displayed on the image display device 1 (all the display units) from the image shot by the camera 2b of the pattern image shooting part 2 (an image of the portion located outside the image display area of all the display units (an image of the outside of the hatched portion of FIG. 4), as well as the display image (pattern image) displayed on all the display units, are included in the image shot by the camera 2b).

More specifically, the display unit position determining part 3 detects the four corners of the display image (pattern image) of the image display device 1 (all the display units) (step ST1).

As a detecting method of detecting the four corners, a known method of detecting the corners of an image by detecting the edges of the image can be used, for example. As an alternative, a point on the pattern image which is the nearest to each of the four corners of the image shot by the camera 2b can be found, and the found points can be defined as the four corners.

In FIG. 4, an example in which the coordinates of the upper left corner of the image shot by the camera 2b are defined as (0, 0), and the coordinates of the positions of the four corners of the pattern image are (1330, 527), (2441, 497), (1295, 1267), and (2431, 1236).

Next, the display unit position determining part 3 sets the number of rows and the number of columns of the display units which construct the image display device 1 (step ST2).

In this embodiment, for the sake of simplicity, it is assumed that a user specifies the number of rows and the number of columns of the display units by using a man machine interface such as a keyboard not shown. The number of rows and the number of columns of the display units are known.

Therefore, the present invention is not limited to this example in which a user specifies the number of rows and the number of columns of the display units. For example, the number of rows and the number of columns of the display units can be inputted automatically from the image display device 1.

Next, the display unit position determining part 3 calculates a projective transformation matrix P showing the correspondence between the coordinate system on the space in which the large number of display units which construct the image display device 1 are installed, and the coordinate system on the pattern image shot by the camera 2b of the pattern image shooting part 2 (step ST3).

More specifically, the display unit position determining part 3 assumes that the image display device 1 is installed on a plane z=0 in a three-dimensional coordinate system first, and defines the position of the upper left corner of the image display device 1 as (0, 0, 0) in the three-dimensional coordinate system and also defines coordinates (Sₓ, S_{y}, S_{z}) on the image display device 1 having an X axis extending along an upper side of the image display device 1 from the point of origin and an Y axis extending along a left side of the image display device 1 from the point of origin.

The display unit position determining part 3 then assumes that each of the display units has a size of “1” (the display units are squares having the same size), and determines the positions of the four corners of each of the display units in the coordinate system on the space in which the image display device 1 is installed.

FIG. 5 is an explanatory drawing showing the positions of the four corners of the image display device 1 in the coordinate system on the space in which the image display device 1 is installed.

The display unit position determining part 3 determines the projective transformation matrix P from the correspondence between the position (Iₓ, I_{y}) of each of the four corners of the pattern image shown in FIG. 4 and the position (Sₓ, S_{y}, S_{z}) of each of the four corners of the image display device 1 shown in FIG. 5. The projective transformation matrix P is shown by the following equation (1).

$$λ ( \begin{matrix}{I}_{x} \\ {I}_{y} \\ 1\end{matrix} ) = ( \begin{matrix}{p}_{11} & {p}_{12} & {p}_{13} \\ {p}_{21} & {p}_{22} & {p}_{23} \\ {p}_{31} & {p}_{32} & {p}_{33}\end{matrix} ) ( \begin{matrix}{S}_{x} \\ {S}_{y} \\ 1 \end{matrix} ) \qquad ( 1 )$$

where λ is a constant having homogeneous coordinates.

When the coordinates of the positions of the four corners of the image display device 1 shown in FIG. 5 are expressed as (S₁ₓ, S_{1y}), (S₂ₓ, S_{2y}), (S₃ₓ, S_{3y}), and (S₄ₓ, S_{4y}), and the coordinates of the positions of the four corners of the pattern image shown in FIG. 4 are expressed as (I₁ₓ, I_{1y}), (I₂ₓ, I_{2y}), (I₃ₓ, I_{3y}), and (I₄ₓ, I_{4y}) the coefficients p₁₁, p₁₂, p₁₃, p₂₁, p₂₂, p₂₃, p₃₁, and p₃₂ of the projective transformation matrix P are determined as shown in the following equation (2).

$$( \begin{matrix}{I}_{1 x} \\ {I}_{1 y} \\ {I}_{2 x} \\ {I}_{2 y} \\ {I}_{3 x} \\ {I}_{3 y} \\ {I}_{4 x} \\ {I}_{4 y}\end{matrix} ) = ( \begin{matrix}{S}_{1 x} & {S}_{1 y} & 1 & 0 & 0 & 0 & - {I}_{1 x} {S}_{1 x} & - {I}_{1 x} {S}_{1 y} \\ 0 & 0 & 0 & {S}_{1 x} & {S}_{1 y} & 1 & - {I}_{1 y} {S}_{1 x} & - {I}_{1 y} {S}_{1 y} \\ {S}_{2 x} & {S}_{2 y} & 1 & 0 & 0 & 0 & - {I}_{2 x} {S}_{2 x} & - {I}_{2 x} {S}_{2 y} \\ 0 & 0 & 0 & {S}_{2 x} & {S}_{2 y} & 1 & - {I}_{2 y} {S}_{2 x} & - {I}_{2 y} {S}_{2 y} \\ {S}_{3 x} & {S}_{3 y} & 1 & 0 & 0 & 0 & - {I}_{3 x} {S}_{3 x} & - {I}_{3 x} {S}_{3 y} \\ 0 & 0 & 0 & {S}_{2 x} & {S}_{3 y} & 1 & - {I}_{3 y} {S}_{3 x} & - {I}_{3 y} {S}_{3 y} \\ {S}_{4 x} & {S}_{4 y} & 1 & 0 & 0 & 0 & - {I}_{4 x} {S}_{4 x} & - {I}_{4 x} {S}_{4 y} \\ 0 & 0 & 0 & {S}_{4 x} & {S}_{4 y} & 1 & - {I}_{4 y} {S}_{4 x} & - {I}_{4 y} {S}_{4 y}\end{matrix} ) ( \begin{matrix}{p}_{11} \\ {p}_{12} \\ {p}_{13} \\ {p}_{21} \\ {p}_{22} \\ {p}_{23} \\ {p}_{31} \\ {p}_{32}\end{matrix} ) \qquad ( 2 )$$

After determining the projective transformation matrix P, the display unit position determining part 3 converts the coordinates (Sₓ, S_{y}, S_{Z}) showing the position where each of the display units is installed into the coordinates (Iₓ, I_{y}) on the pattern image by using the projective transformation matrix P to determine the position of each of the display units in the coordinate system on the pattern image (step ST4).

For example, because the display unit positioned at the upper left corner of the image display device 1 have four corners: an upper left corner having coordinates of (0, 0, 0), an upper right corner having coordinates of (1, 0, 0), a lower left corner having coordinates of (0, 1, 0), and a lower right corner having coordinates of (1, 1, 0), the display unit position determining part converts the coordinates of each of these four corners into the coordinates (Iₓ, I_{y}) on the pattern image by using the projective transformation matrix P.

Furthermore, for example, because the display unit positioned at the lower right corner of the image display device 1 have four corners: an upper left corner having coordinates of (7, 2, 0), an upper right corner having coordinates of (8, 2, 0), a lower left corner having coordinates of (7, 3, 0), and a lower right corner having coordinates of (8, 3, 0), the display unit position determining part converts the coordinates of each of these four corners into the coordinates (Iₓ, I_{y}) on the pattern image by using the projective transformation matrix P.

After the camera 2b of the pattern image shooting part 2 shoots the pattern image, the shooting angle determining part 4 determines the shooting angles α and β of the camera 2b with respect to the center of each of the display units (α is the shooting angle of the camera 2b with respect to the direction of the x axis of the coordinate system on the space in which the image display device 1 is installed, and β is the shooting angle of the camera 2b with respect to the direction of the y axis of the coordinate system on the space in which the image display device 1 is installed) from the pattern image.

Hereafter, the process carried out by the shooting angle determining part 4 will be explained concretely.

First, the shooting angle determining part 4 detects the four corners of the display image (pattern image) of the image display device 1 (all the display units) from the image shot by the camera 2b of the pattern image shooting part 2, like the display unit position determining part 3. The shooting angle determining part then determines the projective transformation matrix equation (1) showing the correspondence between the position (Iₓ, I_{y}) of each of the four corners of the pattern image and the coordinate (Sₓ, S_{y}, S_{z}) of each of the four corners of the image display device 1.

Although the shooting angle determining part 4 in accordance with this Embodiment 1 detects the four corners of the display image (pattern image) of the image display device 1 (all the display units), the shooting angle determining part can alternatively acquire the four corners of the pattern image detected by the display unit position determining part 3.

On the other hand, the coordinates (Sₓ, S_{y}, S_{z}) of each of the four corners of the image display device 1 in the space coordinate system in which the image display device 1 is installed can be brought into correspondence with the coordinates (Iₓ, I_{y}) of each of the four corners of the image display device 1 in the coordinate system on the pattern image shot by the camera 2b by using the following equation (3).

$$λ ( \begin{matrix}{I}_{x} \\ {I}_{y} \\ 1\end{matrix} ) = A [ RT ] ( \begin{matrix}{S}_{x} \\ \begin{matrix}{S}_{y} \\ {S}_{z}\end{matrix} \\ 1 \end{matrix} ) = A [ {R}_{1} {R}_{2} {R}_{3} T ] ( \begin{matrix}{S}_{x} \\ \begin{matrix}{S}_{y} \\ {S}_{z}\end{matrix} \\ 1 \end{matrix} ) \qquad ( 3 )$$

In the equation (3), R is a rotation matrix having three rows and three columns, and can be expressed as R=[R₁ R₂ R₃] by using configuration matrices R₁, R₂, and R₃ each having three rows and one column.

Furthermore, T is a translation matrix having three rows and one column. Therefore, [R₁ R₂ R₃ T] is a matrix having three rows and four columns.

A is a camera intrinsic matrix having three rows and three columns. Camera intrinsic parameters can be calculated by using a method described in the following nonpatent reference 1, for example. Hereafter, it is assumed that the intrinsic parameters of the camera 2b are calculated in advance.

### Nonpatent Reference

Z. Zhang. A flexible new technique for camera calibration. IEEE Transactions on Pattern Analysis and Machine Intelligence, 22 (11): 1330-1334, 2000.

Because S_{z}=0 if it is assumed that the image display device 1 exists in the Z plane of the space coordinate system in which the display units are installed, R₃ can be neglected.

Therefore, the equation (3) can be expressed as shown in the following equation (4).

$$λ ( \begin{matrix}{I}_{x} \\ {I}_{y} \\ 1\end{matrix} ) = A [ RT ] ( \begin{matrix}{S}_{x} \\ \begin{matrix}{S}_{y} \\ {S}_{z}\end{matrix} \\ 1 \end{matrix} ) = A [ {R}_{1} {R}_{2} T ] ( \begin{matrix}{S}_{x} \\ {S}_{y} \\ 1 \end{matrix} ) \qquad ( 4 )$$

Because the equation (1) is equivalent to the equation (4), the following equation (5) is established from the equations (1) and (4). Furthermore, because the camera intrinsic matrix A is known, the matrices R₁, R₂, and T can be determined.

P=A[R₁R₂T] (5)

The matrix R₃ can be determined from the outer product (R1×R2) of the matrix R₁ and the matrix R₂.

Next, the shooting angle determining part 4 assumes the position of the camera 2b in the pattern image shooting part 2 to be a point of origin (0, 0, 0), and also assumes a point (Cₓ, C_{y}, C_{z}) in a camera coordinate system having an X axis and a Y axis respectively extending in the same directions as those of the coordinate system on the pattern image.

An arbitrary point (Cₓ, C_{y}, C_{z}) in this camera coordinate system can be brought into correspondence with a point (Iₓ, I_{y}) in the coordinate system on the pattern image shot by the camera 2b by the following equation (6) by using the camera intrinsic matrix A.

$$λ ( \begin{matrix}{I}_{x} \\ {I}_{y} \\ 1\end{matrix} ) = A ( \begin{matrix}{C}_{x} \\ {C}_{y} \\ {C}_{z}\end{matrix} ) \qquad ( 6 )$$

Therefore, by using the equations (4) and (6), the correspondence between a point (Cₓ, C_{y}, C_{z}) in the camera coordinate system and a point (Sₓ, S_{y}, S_{z}) in the space coordinate system in which the display units are installed can be shown by the following equation (7).

$$( \begin{matrix}{C}_{x} \\ {C}_{y} \\ {C}_{z}\end{matrix} ) = R ( \begin{matrix}{S}_{x} \\ {S}_{y} \\ {S}_{z} \end{matrix} ) + T \qquad ( 7 )$$

The shooting angle determining part 4 converts the position of the camera 2b in the camera coordinate system, i.e. (0, 0, 0) into coordinates (CSₓ, CS_{y}, CS_{z}) in the space coordinate system in which the image display device 1 is installed by using the equation (7).

These coordinates (CSₓ, CS_{y}, CS_{z}) show the position of the camera 2b in the space coordinate system in which the image display device 1 is installed.

The shooting angle determining part 4 calculates the shooting angles α and β from the coordinates of the center position of each of the display units in the space coordinate system in which the image display device 1 is installed, and the coordinates showing the position of the camera 2b.

In this case, a shows the angle along a horizontal direction at which the camera shoots the corresponding display unit with respect to the X axis of the space coordinate system in which the image display device 1 is installed, and β shows the angle along a vertical direction at which the camera shoots the corresponding display unit with respect to the Y axis of the space coordinate system in which the image display device 1 is installed.

FIG. 6 is an explanatory drawing showing the shooting angle α of the camera 2b with respect to the x axis of the image display device 1 (the angle along the horizontal direction).

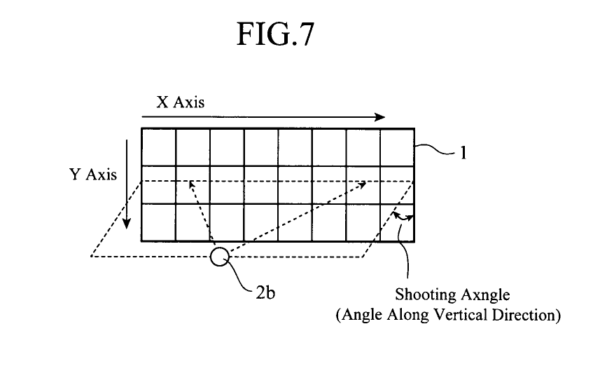

FIG. 7 is an explanatory drawing showing the shooting angle β of the camera 2b with respect to the y axis of the image display device 1 (the angle along the vertical direction).

In this case, the shooting angle determining part 4 assumes that the coordinates of the center of each of the display units in the space coordinate system in which the image display device 1 is installed are equal to those of a point which the shooting angle determining part acquires by adding 0.5 to each of the x and y coordinates of the upper left corner of each of the display units, and considers an image shooting vector connecting between the coordinates of this point and the coordinates (CSₓ, CS_{y}, CS_{z}) showing the position of the camera 2b.

The shooting angle determining part 4 then determines the shooting angle α along the horizontal direction of the camera 2b with respect to the center of each of the display units by projecting the image shooting vector on a plane y=0 in the space coordinate system in which the display unit is installed, and then calculating the angle α between the projected image shooting vector and a unit vector (1, 0, 0) in the direction of the x axis.

The shooting angle determining part 4 also determines the shooting angle β along the vertical direction of the camera 2b with respect to the center of each of the display units by projecting the image shooting vector on a plane x=0 in the space coordinate system in which the display unit is installed, and then calculating the angle β between the projected image shooting vector and a unit vector (0, 1, 0) in the direction of the y axis.

After the display unit position determining part 3 determines the position of each of the display units, the brightness measuring part 5 determines the display image displayed on each of the display units in the pattern image shot by the camera 2b of the pattern image shooting part 2 with reference to the position of each of the display units, and calculates the average L of the values of the plurality of pixels which construct the display image (the brightness of each of the display units).

Hereafter, the process carried out by the brightness measuring part 5 will be explained concretely.

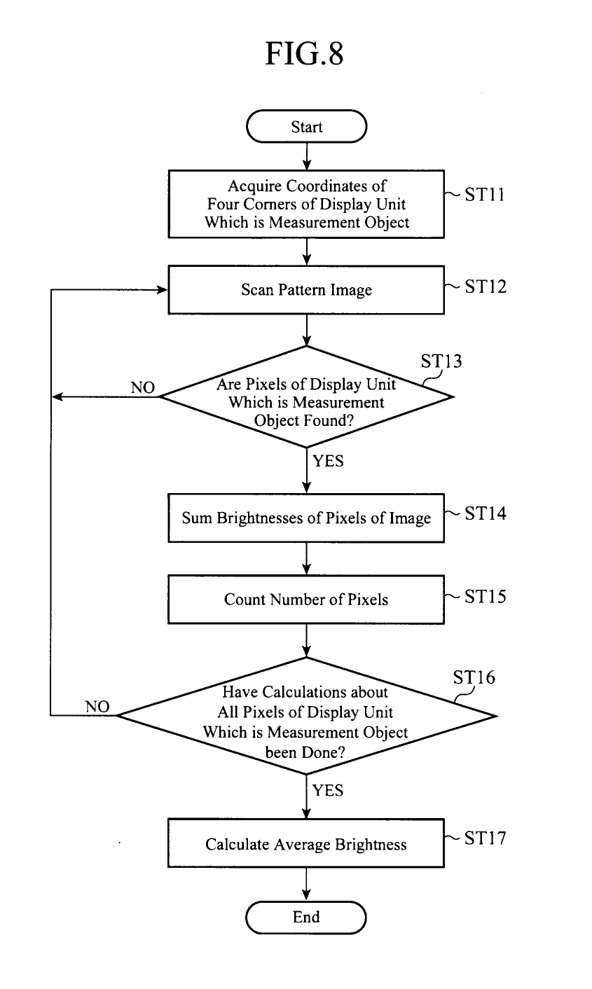

FIG. 8 is a flow chart showing the process carried out by the brightness measuring part 5 of the brightness adjusting device in accordance with Embodiment 1 of the present invention.

First, the brightness measuring part 5 acquires the coordinates (Iₓ, I_{y}) of each of the four corners of each of the display units in the coordinate system on the pattern image shot by the camera 2b from the display unit position determining part 3.

The brightness measuring part 5 focuses attention to one display unit (a display unit which is a measurement object for which the brightness has not been calculated) among the large number of display units which construct the image display device 1 (step ST11), and determines the display image of the display unit from the pattern image shot by the camera 2b with reference to the coordinates (Iₓ, I_{y}) of each of the four corners of the display unit which is a measurement object.

More specifically, the brightness measuring part 5 determines the pixels which construct the display image of the display unit which is a measurement object among all the pixels which construct the pattern image shot by the camera 2b (steps ST12 and ST13).

After determining all the pixels which construct the display image of the display unit which is a measurement object, the brightness measuring part 5 sums the brightnesses (pixel values) of all the pixels while counting the number of the pixels which construct the display image (steps ST14 to ST16).

The brightness measuring part 5 then divides the sum total of the brightnesses of all the pixels by the number of the pixels which construct the display image to calculate the average brightness L of the pixels which construct the display image (step ST17).

The brightness measuring part 5 outputs the average brightness L of the pixels which construct the display image as the brightness of the display unit to the light distribution characteristic determining part 6 and the correction value calculating part 8.

The brightness measuring part 5 calculates the brightness of each of all the display units which construct the image display device 1.

After the display unit position determining part 3 determines the position of each of the display units, the shooting angle determining part 4 determines the shooting angles α and β, and the brightness measuring part 5 then measures the brightness L of each of the display units, the light distribution characteristic determining part 6 determines the light distribution characteristic equation f(α,β) of the image display device 1 from the position of each of the display units, the shooting angles α and β, and the brightness L of each of the display units.

The light distribution characteristic equation f(α,β) is a computation expression showing how brightness falls when the angle with respect to each of the display units which construct the image display device 1 varies by assuming the brightness of the display unit to be 100% when the brightness is measured from just above the display unit.

Hereafter, the process carried out by the light distribution characteristic determining part 6 will be explained concretely.

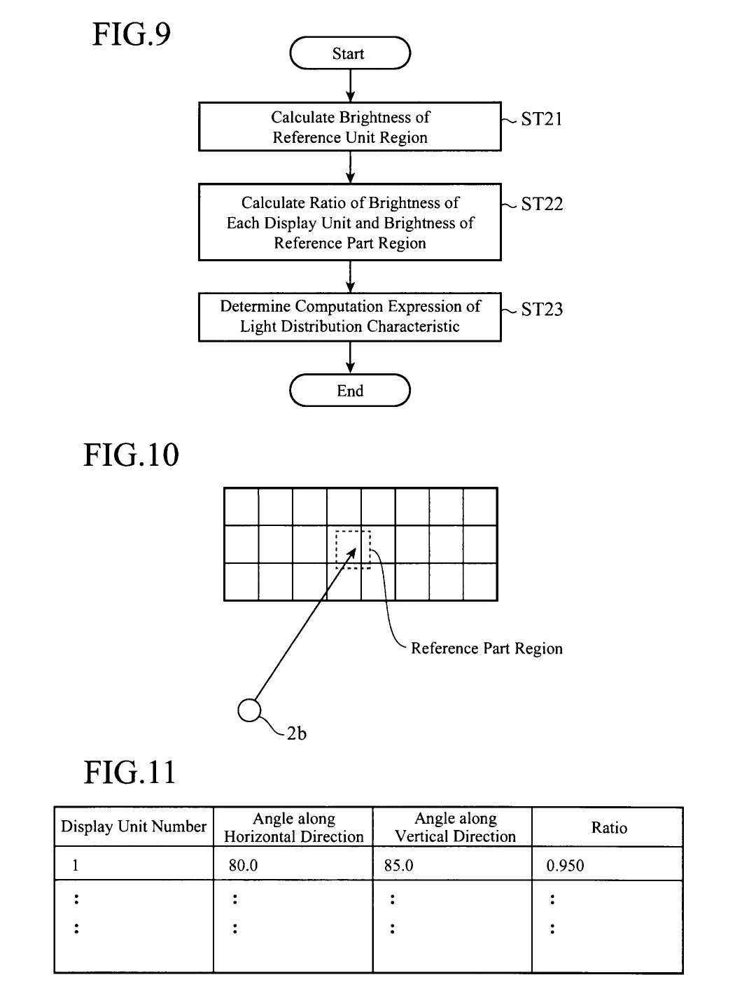

FIG. 9 is a flow chart showing the process carried out by the light distribution characteristic determining part 6 of the brightness adjusting device in accordance with Embodiment 1 of the present invention.

First, the light distribution characteristic determining part 6 acquires the coordinates (CSₓ, CS_{y}, CS_{z}) showing the position of the camera 2b in the space coordinate system in which the image display device 1 is installed from the shooting angle determining part 4, and also acquires the point on the image display device 1 which is just opposite to the camera 2b (the point is in the space coordinate system in which the image display device 1 is installed). In this case, the point on the image display device 1 which is just opposite to the camera 2b is the one which is acquired by projecting the coordinates showing the position of the camera 2b on the plane Z=0. More specifically, the point is (CSₓ, CS_{y}, 0).

FIG. 10 is an explanatory drawing showing a reference unit region which will be mentioned below. In the figure, a position shown by an arrow corresponds to the point on the image display device 1 which is just opposite to the camera 2b.

After determining the point on the image display device 1 which is just opposite to the camera 2b, the light distribution characteristic determining part 6 defines a region having a size equal to one display unit and centered at the point which is just opposite to the camera 2b as the reference unit region (in the figure, a region enclosed by a dotted line), as shown in FIG. 10, and calculates the brightness of the reference unit region with reference to the brightness L of each of the display units measured by the brightness measuring part 5 (step ST21).

Although the reference unit region extends over four display units in the example of FIG. 10, the areas of the portions in which the reference unit region overlaps the four display units can be determined because the positions of the four display units are acquired from the display unit position determining part 3 and the position of the reference unit region is known.

When the areas of the portions in which the reference unit region overlaps the four display units are determined, the brightness of the reference unit region (the average brightness of the plurality of pixels which construct the reference unit region) can be calculated from the ratios among the areas and the brightnesses L of the four display units acquired from the brightness measuring part 5.

After calculating the brightness of the reference unit region, the light distribution characteristic determining part 6 calculates the ratio of the brightness L of each of the display units measured by the brightness measuring part 5 and the brightness of the reference unit region (step ST22).

After calculating the ratio of the brightness L of each of the display units and the brightness of the reference unit region, the light distribution characteristic determining part 6 creates a brightness information table including the ratio and the shooting angles α and β determined by the shooting angle determining part 4.

FIG. 11 is an explanatory drawing showing an example of the brightness information table created by the light distribution characteristic determining part 6.

After creating the brightness information table, the light distribution characteristic determining part 6 determines an equation used for calculating the light distribution characteristic of the image display device 1 with reference to the brightness information table (step ST23).

As the equation used for calculating the light distribution characteristic of the image display device 1, for example, an equation like the following equation (8) in which the light distribution characteristic f(α,β) varies according to the shooting angles α and β of each of the display units can be considered.

f(α,β)=a*α²+b*β²+c*α*β+d*α+e*β+f (8)

Coefficients a, b, c, d, e, and f in the equation (8) can be approximated by executing a known method, such as the least square method, using the data in the brightness information table.

After determining the light distribution characteristic computation expression f(α,β) of the image display device 1 by using, for example, the equation (8), the light distribution characteristic determining part 6 stores the light distribution characteristic equation f(α,β) in the light distribution characteristic storage part 7.

Although the example in which the light distribution characteristic storage part 7 stores the light distribution characteristic computation expression f(α,β) determined by the light distribution characteristic determining part 6 is shown in this Embodiment 1, a light distribution characteristic computation expression f(α,β) of a standard display unit (a display unit having display characteristics similar to those of each display unit which constructs the image display device 1) can be alternatively stored, or a light distribution characteristic computation expression f(α,β) created from data measured by a light distribution characteristic measuring device for exclusive use can be alternatively stored.

Furthermore, although in this Embodiment 1 the example in which the light distribution characteristic is determined by carrying out image shooting only once is shown, the light distribution characteristic can be alternatively determined from images which are acquired by shooting the image display device 1 from various positions or angles.

Similarly, by extracting a value corresponding to one display unit from a brightness information table which is created by shooting the image display device from various positions or angles, the light distribution characteristic of a target display unit can be alternatively determined.

After the light distribution characteristic determining part 6 stores the light distribution characteristic computation expression f(α,β) of the image display device 1 shown by the equation (8) in the light distribution characteristic storage part 7, the correction value calculating part 8 calculates a correction value H used for adjustment of the brightness of each of the large number of display units which construct the image display device 1 in consideration of the light distribution characteristic computation expression f(α,β), the brightness L of each of the display units measured by the brightness measuring part 5, and the shooting angles α and β of each of the display units calculated by the shooting angle determining part 4.

Hereafter, the process carried out by the correction value calculating part 8 will be explained concretely.

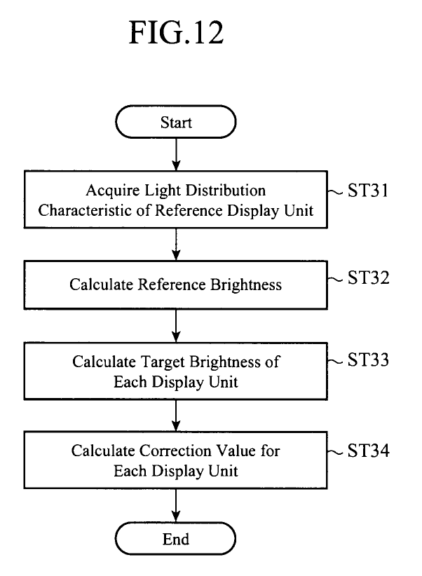

FIG. 12 is a flow chart showing the process carried out by the correction value calculating part 8 of the brightness adjusting device in accordance with Embodiment 1 of the present invention.

First, the correction value calculating part 8 specifies a reference display unit from among the large number of display units which construct the image display device 1.

The user specifies the reference display unit by using a man machine interface such as a keyboard not shown. For example, a display unit which is close to the center of the image display device 1 is specified as the reference display unit.

After specifying the reference display unit, the correction value calculating part 8 acquires the shooting angles α_{T} and β_{T} of the reference display unit from the shooting angle determining part 4, and applies α_{T} and β_{T} to the light distribution characteristic computation expression of the image display device 1, which is stored in the light distribution characteristic storage part 7, to acquire the value of the light distribution characteristic computation expression. More specifically, the correction value calculating part acquires the light distribution characteristic value f(α_{T},β_{T}) of the display unit (step ST31).

After acquiring the light distribution characteristic value f(α_{T},β_{T}) of the reference display unit, the correction value calculating part 8 acquires the brightness L of the reference display unit from the brightness measuring part 5, and then divides the brightness L by the light distribution characteristic value f(α_{T},β_{T}) to calculate a reference brightness L_{ref} (=L/f(α_{T},β_{T})) (step ST32).

Next, the correction value calculating part 8 acquires the shooting angles α and β of each of the display units from the shooting angle determining part 4, applies α and β to the computation expression for computing the light distribution characteristic, which is stored in the light distribution characteristic storage part 7, to acquire the light distribution characteristic value f(α,β) of each of the display units, and then multiplies the light distribution characteristic value f(α,β) by the reference brightness L_{ref} to calculate a target brightness L_{tgt} (=L_{ref}×f(α,β)) which is a target brightness of each of the display units (step ST33).

After calculating the target brightness L_{tgt}, the correction value calculating part 8 divides the target brightness L_{tgt} by the brightness L of each of the display units measured by the brightness measuring part 5 to calculate a correction value H (=L_{tgt}/L) used for adjustment of the brightness of each of the display units (step ST34).

After the correction value calculating part 8 calculates the correction value H used for adjustment of the brightness of each of the display units, the brightness adjusting part 9 multiplies the brightness L of each of the display units which construct the image display device by the correction value H (=L_{tgt}/L) to adjust the brightness of each of the display units.

As can be seen from the above description, the brightness adjusting device in accordance with this Embodiment 1 is constructed in such a way as to include the pattern image shooting part 2 for displaying a pattern image for brightness measurement on the plurality of display units which construct the image display device 1 to shoot a pattern image which is a display image displayed on the plurality of display units, the display unit position determining part 3 for determining the position of each of the display units in a coordinate system on the pattern image shot by the pattern image shooting part 2, the shooting angle determining part 4 for determining the shooting angles of the pattern image shooting part 2 with respect to each of the display units from the pattern image shot by the pattern image shooting part 2, and the brightness measuring part 5 for determining the display image displayed on each of the display units in the pattern image shot by the pattern image shooting part 2 with reference to the position of each of the display units determined by the display unit position determining part 3 to measure the brightness of each of the display units, and adjust the brightness of the image display device 1 in consideration of the light distribution characteristic of the image display device 1, the shooting angles with respect to each of the display units which is determined by the shooting angle determining part 4, and the brightness of each of the display units measured by the brightness measuring part 5, there is provided an advantage of being able to adjust the brightness of the image display device 1 and reduce luminance spots without constraints on the camera shooting position.

Furthermore, because the brightness adjusting device in accordance with this Embodiment 1 is constructed in such a way as to calculate a correction value H used for adjustment of the brightness of each of the plurality of display units in consideration of the light distribution characteristic of the image display device 1, the shooting angles with respect to each of the display units which is determined by the shooting angle determining part 4, and the brightness of each of the display units measured by the brightness measuring part 5, and adjust the brightness of each of the plurality of display units by using the correction value H, there is provided an advantage of being able to adjust the brightness of each of the plurality of display units while preventing luminance spots from occurring.

In addition, because the brightness adjusting device in accordance with this Embodiment 1 is constructed in such a way that the shooting angle determining part 4 determines a coordinate transformation matrix showing the correspondence between a coordinate system on a space in which the plurality of display units which construct the image display device 1 are installed, and a coordinate system on the pattern image shot by the pattern image shooting part 2, and converts the position of the pattern image shooting part 2 and the position where each of the display units is installed into positions on the same coordinate system by using the coordinate transformation matrix to determine the shooting angles, there is provided an advantage of being able to determine the shooting angles with respect to each of all the display units which construct the image display device 1 by simply displaying a pattern image having a single color on each of the display units, for example, and shooting the pattern image which is the display image displayed on each of the display units only once.

Because the brightness adjusting device in accordance with this Embodiment 1 is constructed in such a way as to determine a coordinate transformation matrix P showing the correspondence between the coordinate system on the space in which the plurality of display units which construct the image display device 1 are installed, and the coordinate system on the pattern image shot by the pattern image shooting part 2, and converts the coordinates showing the position where each of the display units is installed into coordinates on the pattern image by using the coordinate transformation matrix P, there is provided an advantage of being able to determine the position of each of all the display units by simply displaying a pattern image having a single color on each of the display units, for example, and shooting the pattern image which is the display image displayed on each of the display units only once.

Although in this Embodiment 1 the example in which the pattern image shooting part 2 displays an image having a single color, such as only green, on each of the display units as the pattern image for brightness measurement is shown, the pattern image shooting part 2 can alternatively display a pattern image which makes only the display elements at the four corners of each of the display units light up, and then recognize the positions of the four corners by using a known image recognition method such as labeling. In this case, the pattern image shooting part calculates the coordinates on the shot image of the position of each of the four corners which the pattern image shooting part has recognized, and an angle at which to display the image.

Furthermore, although in this Embodiment 1 the example in which the shooting angle determining part 4 determines the angle along the horizontal direction and the angle along the vertical direction as the shooting angles is shown, the shooting angle determining part can alternatively determine an angle between the normal vector to the display surface of the image display device 1 and a vector connecting between one point on the image display device 1 and the position of the camera 2b, and take into consideration the light distribution characteristic according to this angle.

### Embodiment 2

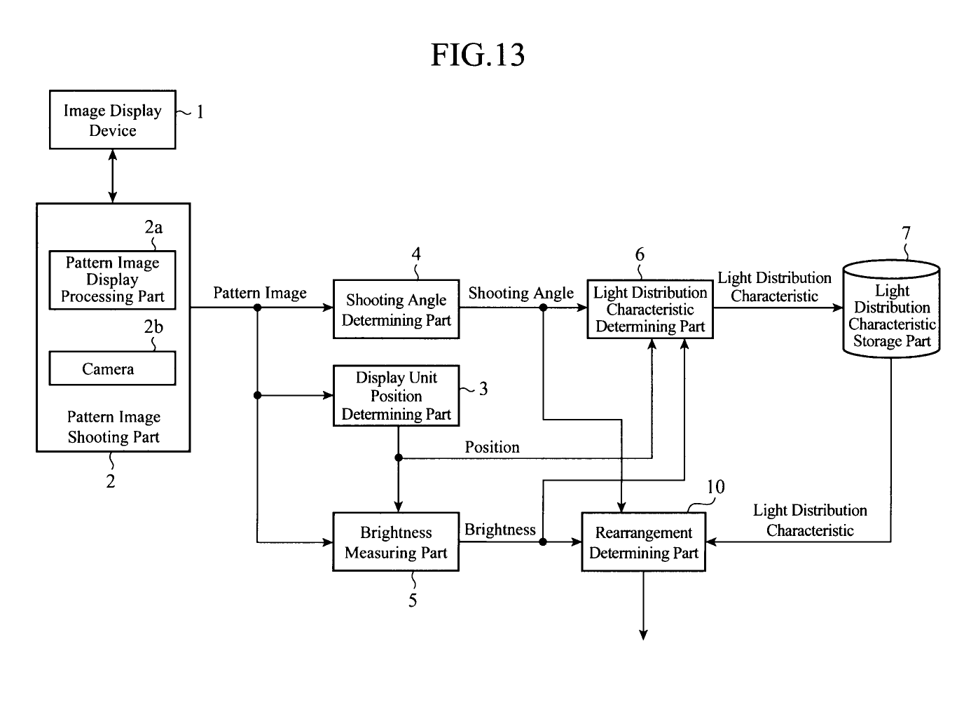

FIG. 13 is a block diagram showing a brightness adjusting device in accordance with Embodiment 2 of the present invention. In the figure, because the same reference numerals as those shown in FIG. 1 denote the same components or like components, the explanation of the components will be omitted hereafter.

A rearrangement position determining part 10 carries out a process of determining a relative brightness level of each of a plurality of display units which construct an image display device 1 in consideration of a light distribution characteristic of an image display device 1 stored in a light distribution characteristic storage part 7, shooting angles determined by a shooting angle determining part 4, and the brightness of each of the display units measured by a brightness measuring part 5 to determine the position where each of the plurality of display units is to be rearranged in consideration of the relative brightness level. The rearrangement position determining part 10 constructs a brightness adjusting unit.

In above-mentioned Embodiment 1, the brightness adjusting device which calculates a correction value H used for adjustment of the brightness of each of the plurality of display units which construct the image display device 1 in consideration of the light distribution characteristic of the image display device 1, the shooting angles determined by the shooting angle determining part 4, and the brightness of each of the display units measured by the brightness measuring part 5, and which adjusts the brightness of the image display device 1 by adjusting the brightness of each of the plurality of display units by using the correction value H is shown. In contrast, the brightness adjusting device in accordance with Embodiment 2 of the present invention can determine the relative brightness level of each of the plurality of display units which construct the image display device 1 in consideration of the light distribution characteristic of the image display device 1, the shooting angles determined by the shooting angle determining part 4, and the brightness of each of the display units measured by the brightness measuring part 5, and adjust the brightness of the image display device 1 by rearranging the plurality of display units in consideration of the relative brightness level.

Next, the operation of the brightness adjusting device will be explained.

However, because the brightness adjusting device has the same structure as that in accordance with above-mentioned Embodiment 1 except for the rearrangement position determining part 10, only a process carried out by the rearrangement position determining part 10 will be explained.

The rearrangement position determining part 10 acquires the shooting angles α and β at which each of the display units is shot from the shooting angle determining part 4, and applies α and β to a computation expression showing the light distribution characteristic of the image display device 1, which is stored in the light distribution characteristic storage part 7 to acquire the light distribution characteristic value f(α,β) of each of the display units.

After acquiring the light distribution characteristic value f(α,β) of each of the display units, the rearrangement position determining part 10 divides the brightness L of each of the display units measured by the brightness measuring part 5 by the light distribution characteristic value f(α,β) to calculate a normalized brightness Lₙ of each of the display units.

Lₙ=L/f(α,β) (9)

The rearrangement position determining part 10 also calculates the average Lₐᵥₑ of the normalized brightnesses Lₙ of all the display units which construct the image display device 1.

After calculating the average Lₐᵥₑ of the normalized brightnesses Lₙ of all the display units, the rearrangement position determining part 10 divides the normalized brightness Lₙ of each of the display units by the average Lₐᵥₑ to calculate the relative brightness L_{c} of each of the display units.

After calculating the relative brightness L_{c} of each of the display units, the rearrangement position determining part 10 determines the position where each of the plurality of display units is to be rearranged in consideration of the relative brightness level L_{c}.

For example, the rearrangement position determining part determines the position where each of the plurality of display units is to be rearranged in such a way that the plurality of display units are arranged in descending order of relative brightness L_{c} or in ascending order of relative brightness L_{c}.

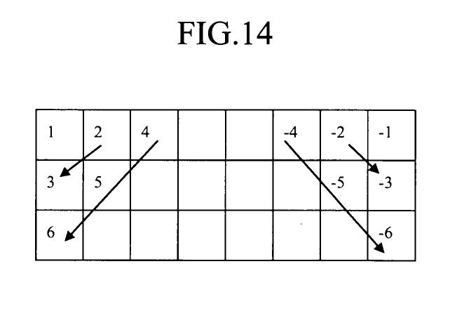

FIG. 14 is an explanatory drawing showing an example of the rearrangement of the plurality of display units.

In FIG. 14, an example in which six display units are rearranged at positions designated by 1 to 6 in descending order of relative brightness L_{c}, and an example in which six display units are rearranged at positions designated by −1 to −6 in ascending order of relative brightness L_{c} are shown.

After determining the position where each of the display units is to be rearranged, the rearrangement position determining part 10 outputs information showing the position where each of the display units is to be rearranged.

As a result, for example, when a user rearranges each of the display units at the position where the display unit is to be rearranged and which is determined by the rearrangement position determining part 10, the brightness of the image display device 1 is adjusted.

As can be seen from the above description, the brightness adjusting device in accordance with this Embodiment 2 is constructed in such a way that the rearrangement position determining part 10 determines the relative brightness level of each of the plurality of display units which construct the image display device 1 in consideration of the light distribution characteristic of the image display device 1 stored in the light distribution characteristic storage part 7, the shooting angles determined by the shooting angle determining part 4, and the brightness of each of the display units measured by the brightness measuring part 5 to determine the position where each of the plurality of display units is to be rearranged in consideration of the relative brightness level. Therefore, in a case in which luminance spots are not seen when viewed from the front, but luminance spots are seen when viewed from a slanting direction, for example, the brightness adjusting device provides an advantage of being able to reduce the luminance spots which are seen when viewed in a slanting direction from the camera 2b set as an eye point without impairing the uniformity of the brightness when viewed from the front.

### Embodiment 3

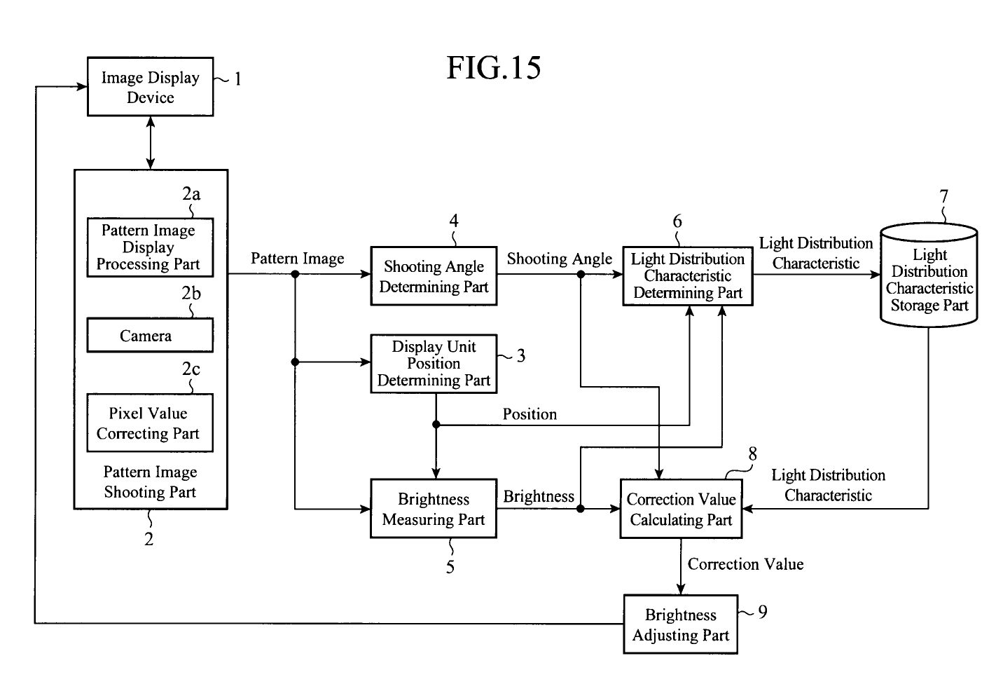

FIG. 15 is a block diagram showing a brightness adjusting device in accordance with Embodiment 3 of the present invention. In the figure, because the same reference numerals as those shown in FIG. 1 denote the same components or like components, the explanation of the components will be omitted hereafter.

A pixel value correcting part 2c of a pattern image shooting part 2 carries out a process of correcting the pixel values of each of image sensors by using a correction value acquired for the corresponding one of the image sensors which construct a camera 2b, and creating a pattern image from the corrected pixel values.

Although in this Embodiment 3 an example in which the pixel value correcting part 2c is applied to the brightness adjusting device of FIG. 1 is shown, the pixel value correcting part can be alternatively applied to the brightness adjusting device of FIG. 13.

Although in above-mentioned Embodiments 1 and 2 the example in which the camera 2b of the pattern image shooting part 2 acquires a pattern image by shooting an image of an area covering the whole surface of the image display device 1 (an image including the display images displayed on all the display units) is shown, the brightness adjusting device can correct the pixel values of each of the image sensors by using the correction value acquired for the corresponding image sensor, and acquire a pattern image from the corrected pixel values in a case in which the camera 2b is comprised of three color image sensors including R-color, G-color, and B-color image sensors.

Hereafter, a process carried out by the pattern image shooting part 2 in this Embodiment 3 will be explained concretely.

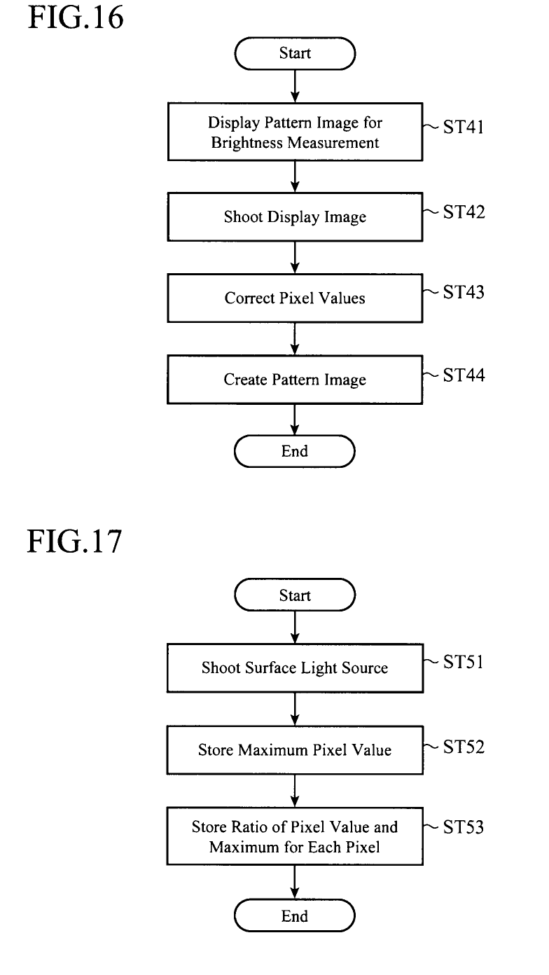

FIG. 16 is a flow chart showing the process carried out by the pattern image shooting part 2 of the brightness adjusting device in accordance with Embodiment 3 of the present invention.

FIG. 17 is a flow chart showing a process of calculating the correction value for each of the image sensors.

A pattern image display processing part 2a of the pattern image shooting part 2 displays an image having a single color, such as only green, on all the display units of the image display device 1 as a pattern image for brightness measurement, like that any one of above-mentioned Embodiments 1 and 2 (step ST41).

After the pattern image display processing part 2a displays the pattern image on all the display units, the camera 2b of the pattern image shooting part 2 shoots an image of an area covering the whole surface of the image display device 1 (an image including the display images displayed on all the display units), like that according to any one of above-mentioned Embodiments 1 and 2 (step ST42).

The pixel value correcting part 2c of the pattern image shooting part 2 reads the pixel values of each of the image sensors of the camera 2b, and corrects the pixel values of each of the image sensors by using the correction value for the corresponding image sensor which the pixel value correcting part has calculated (step ST43). The process of calculating the correction value for each of the image sensors will be mentioned below.

After correcting the pixel values of each of the image sensors, the pixel value correcting part 2c of the pattern image shooting part 2 creates a pattern image (this pattern image includes an image of a portion located outside the image display area of all the display units (an image of the outside of a hatched portion of FIG. 4)) from the corrected pixel values (step ST44).

Hereafter, the process of calculating the correction value for each of the image sensors will be explained.

The camera 2b of the pattern image shooting part 2 shoots a surface light source which consists of a single light source having the same brightness (step ST51).

After the camera 2b shoots the surface light source, the pixel value correcting part 2c of the pattern image shooting part 2 reads the pixel values of each of the image sensors of the camera 2b, and stores a maximum of the pixel values (step ST52).

The pixel value correcting part 2c of the pattern image shooting part 2 divides the pixel values of each of the image sensor of the camera 2b by the above-mentioned maximum to calculate the correction value of the corresponding image sensor (=the pixel values of each of the image sensors/the maximum) (step ST53).

When correcting the pixel value of each of the image sensors, the pattern image shooting part 2 corrects the pixel values of each of the image sensors by dividing the pixel values of the corresponding image sensor by the above-mentioned correction value.

As can be seen from the above description, the brightness adjusting device in accordance with this Embodiment 3 is constructed in such a way as to, in which the camera 2b is comprised of a plurality of image sensors, correct the pixel values of each of the image sensors by using a correction value acquired for the corresponding image sensor, and acquire a pattern image from the corrected pixel values, the brightness adjusting device provides an advantage of being able to detect the four corners of the image display device 1 more correctly while being able to measure the brightness correctly.

### Embodiment 4

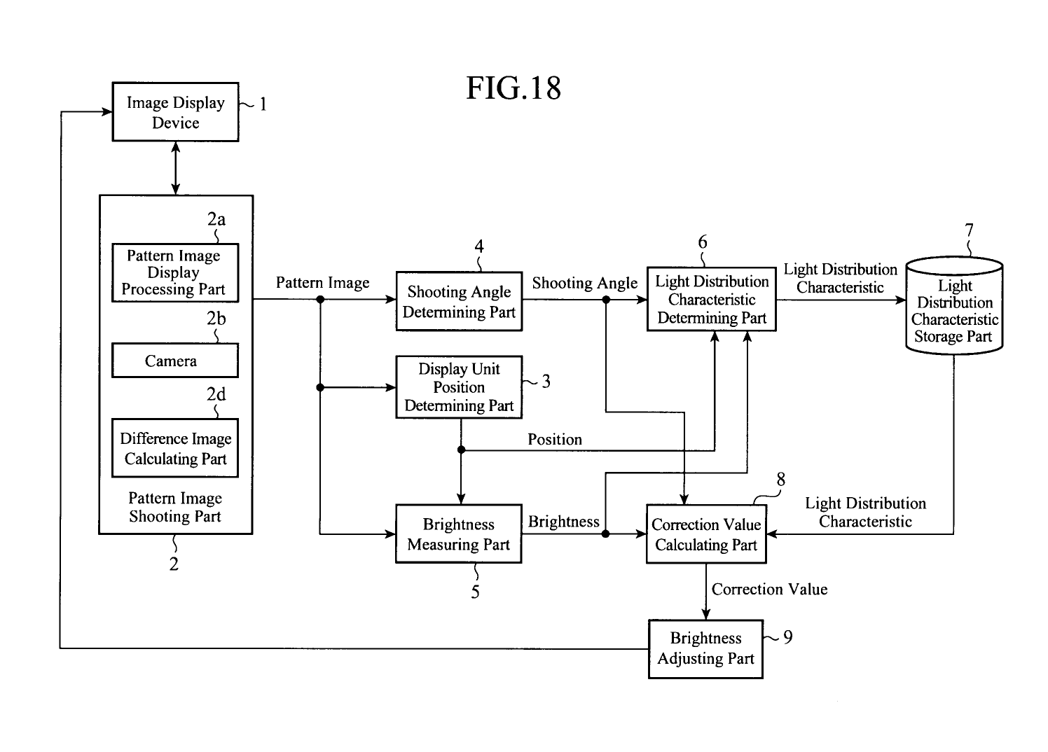

FIG. 18 is a block diagram showing a brightness adjusting device in accordance with Embodiment 4 of the present invention. In the figure, because the same reference numerals as those shown in FIG. 1 denote the same components or like components, the explanation of the components will be omitted hereafter.

A difference picture calculating part 2d of a pattern image shooting part 2 carries out a process of calculating a difference image between a display image displayed on all display units which is shot by a camera 2b when a pattern image is displayed on all the display units, and a display image displayed on all the display units which is shot by the camera 2b when all the display units are turned off completely, and outputting the difference image to a display unit position determining part 3, a shooting angle determining part 4, and a brightness measuring part 5 as a pattern image.

Although in this Embodiment 4 an example in which the difference image calculating part 2d is applied to the brightness adjusting device of FIG. 1, the difference image calculating part can be alternatively applied to either of the brightness adjusting devices shown in FIGS. 13 and 15.

In above-mentioned Embodiments 1 to 3, the example in which after the pattern image display processing part 2a of the pattern image shooting part 2 displays an image having a single color, such as only green, on all the display units of the image display device 1 as a pattern image for brightness measurement, the camera 2b of the pattern image shooting part 2 shoots an image of an area covering the whole surface of the image display device 1 (an image including display images displayed on all the display units) to acquire a pattern image is shown. As an alternative, the pattern image display processing part 2a of the pattern image shooting part 2 can display a pattern image for brightness measurement on the plurality of display units and the camera 2b of the pattern image shooting part 2 can shoot a display image displayed on the plurality of display units, and, after that, the pattern image display processing part 2a of the pattern image shooting part 2 can then turn off the plurality of display units completely, and the camera 2b of the pattern image shooting part 2 can shoot a display image on the plurality of display units which are turned off completely and the difference image calculating part 2d can output the difference image between both the display images to the display unit position determining part 3, the shooting angle determining part 4, and the brightness measuring part 5 as the pattern image.

Hereafter, a process carried out by the pattern image shooting part 2 in this Embodiment 4 will be explained concretely.

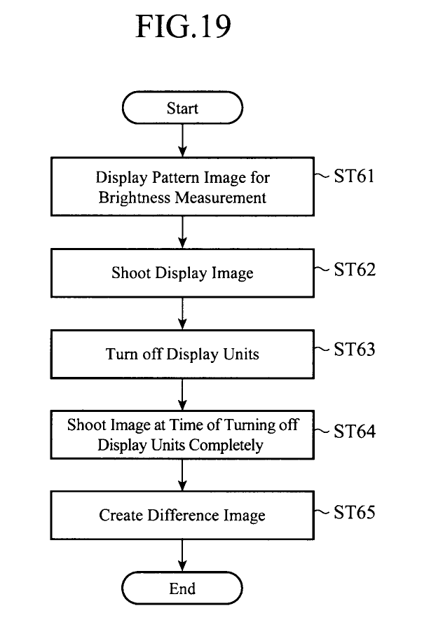

FIG. 19 is a flow chart showing the process carried out by the pattern image shooting part 2 of the brightness adjusting device in accordance with Embodiment 4 of the present invention.

The pattern image display processing part 2a of the pattern image shooting part 2 displays an image having a single color, such as only green, on all the display units of the image display device 1 as a pattern image for brightness measurement, like that any one of above-mentioned Embodiments 1 to 3 (step ST61).

After the pattern image display processing part 2a displays the pattern image on all the display units, the camera 2b of the pattern image shooting part 2 shoots an image of an area covering the whole surface of the image display device 1 (an image including display images displayed on all the display units), like that according to any one of above-mentioned Embodiments 1 to 3 (step ST62).

Next, the pattern image display processing part 2a of the pattern image shooting part 2 turns off all the display units of the image display device 1 completely (step ST63). As an alternative, the pattern image display processing part displays an image of a single color different from that in which the above-mentioned pattern image for brightness measurement is displayed on all the display units.

When the pattern image display processing part 2a turns off all the display units completely, the camera 2b of the pattern image shooting part 2 shoots an image of an area covering the whole surface of the image display device 1 at the time of completely turning off all the display units (step ST64).

The difference image calculating part 2d of the pattern image shooting part 2 creates a difference image between the image shot by the camera 2b in step ST62 and the image shot by the camera 2b in step ST64 (step ST65), and outputs the difference image to the display unit position determining part 3, the shooting angle determining part 4, and the brightness measuring part 5 as the pattern image.

Because the brightness adjusting device in accordance with this Embodiment 4 is constructed in such a way as to output the difference image to the display unit position determining part 3, the shooting angle determining part 4, and the brightness measuring part 5 as the pattern image, the brightness adjusting device provides an advantage of being able to detect the four corners of the image display device 1 more correctly while being able to measure the brightness correctly.

### INDUSTRIAL APPLICABILITY

The present invention is suitable for a brightness adjusting device which, when adjusting the brightness of each of a large number of display units which construct an image display device 1, adjusts the brightness of the image display device and needs to reduce luminance spots without constraints on the camera shooting position.

1. A brightness adjusting device comprising:
a pattern image shooting unit for displaying a pattern image for brightness measurement on a plurality of display units which construct an image display device to shoot a pattern image which is a display image displayed on the plurality of display units;
a display unit position determining unit for determining a position of each of the display units in a coordinate system on the pattern image shot by said pattern image shooting unit;
a shooting angle determining unit for determining a shooting angle of said pattern image shooting unit with respect to each of the display units from the pattern image shot by said pattern image shooting unit;
a brightness measuring unit for determining a display image displayed on each of the display units in the pattern image shot by said pattern image shooting unit with reference to the position of each of the display units determined by said display unit position determining unit to measure brightness of each of the display units; and
a brightness adjusting unit for acquiring a light distribution characteristic value of said image display device from the shooting angle determined by said shooting angle determining unit to adjust brightness of said image display device in consideration of said light distribution characteristic value and the brightness of each of the display units measured by said brightness measuring unit.

2. The brightness adjusting device according to claim 1, wherein the brightness adjusting unit acquires a light distribution characteristic value from both the light distribution characteristic of the image display device and the shooting angle determined by the shooting angle determining unit, calculates a correction value used for adjustment of the brightness of each of the plurality of display units which construct said image display device in consideration of said light distribution characteristic value and the brightness of each of the display units measured by the brightness measuring unit, and adjusts the brightness of each of the plurality of display units by using said correction value.

3. The brightness adjusting device according to claim 1, wherein the brightness adjusting unit acquires a light distribution characteristic value from both the light distribution characteristic of the image display device and the shooting angle determined by the shooting angle determining unit, determines a relative brightness level of each of the plurality of display units which construct said image display device in consideration of said light distribution characteristic value and the brightness of each of the display units measured by the brightness measuring unit, and determines a position where each of the plurality of display units is to be rearranged in consideration of the relative brightness level.

4. The brightness adjusting device according to claim 1, wherein the shooting angle determining unit determines a coordinate transformation matrix showing a correspondence between a coordinate system on a space in which the plurality of display units which construct the image display device are installed, and a coordinate system on the pattern image shot by the pattern image shooting unit, and converts a position of the pattern image shooting unit and a position where each of the display units is installed into positions on a same coordinate system by using said coordinate transformation matrix to determine the shooting angle.

5. The brightness adjusting device according to claim 1, wherein the display unit position determining unit determines a coordinate transformation matrix showing a correspondence between a coordinate system on a space in which the plurality of display units which construct the image display device are installed, and a coordinate system on the pattern image shot by the pattern image shooting unit, and converts coordinates showing a position where each of the display units is installed into coordinates on said pattern image by using said coordinate transformation matrix.

6. The brightness adjusting device according to claim 1, wherein when shooting the pattern image by using a plurality of image sensors, the pattern image shooting unit corrects pixel values of each of the image sensors by using a correction value for each image sensor, and acquires a pattern image from the corrected pixel values.

7. The brightness adjusting device according to claim 1, wherein the pattern image shooting unit displays the pattern image for brightness measurement on the plurality of display units to shoot a display image displayed on the plurality of display units, and also turns off the plurality of display units completely to shoot a display image displayed on the plurality of display units which are in the completely turned-off state, and outputs a difference image between both the display images to the display unit position determining unit and the brightness measuring unit as the pattern image.

8. The brightness adjusting device according to claim 1, wherein said brightness adjusting device includes a light distribution characteristic determining unit for determining the light distribution characteristic of the image display device from the shooting angle determined by the shooting angle determining unit, the position of each of the display units determined by the display unit position determining unit, and the brightness of each of the display units measured by the brightness measuring unit.
